(19) United States
(12) Patent Application Publication
(10) Pub. No.: US 2024/0076069 A1
(43) Pub. Date: Mar. 7, 2024

(54) Integrated Engine/Generator for Hybrid Drones

(71) Applicant: Istari, Inc., Charleston, SC (US)

(72) Inventors: William Roper, JR., Charleston, SC (US); Christopher Benson, Charleston, SC (US); Long N. Phan, Charleston, SC (US); Mohammad Imani Nejad, Newton, MA (US); Trey Nguyen, Malden, MA (US)

(21) Appl. No.: 17/940,792

(22) Filed: Sep. 8, 2022

Related U.S. Application Data
(60) Provisional application No. 63/404,036, filed on Sep. 6, 2022.

(51) Int. Cl. B64U 50/19; B60L 53/00; B64C 39/02; B64D 27/24; B64D 33/08; B64D 35/02

(52) U.S. Cl. CPC B64U 50/19; B60L 53/00; B64C 39/024; B64D 27/24; B64D 33/08; B64D 35/02; B64D 2027/026

(57) ABSTRACT

An unmanned aerial vehicle comprises a central body; at least one rotor motor configured to drive at least one propeller to rotate, rotation of the at least one propeller generating thrust and causing the unmanned aerial vehicle to fly; and an integrated micro hybrid generator system configured to provide power to the at least one rotor motor. The integrated micro hybrid generator system includes an engine configured to generate mechanical energy, and a generator motor directly coupled to the engine and configured to generate AC power using the mechanical energy generated by the engine.

### RELATED APPLICATIONS

This application claims priority to U.S. Provisional Application No. 63/404,036, filed on Sep. 6, 2022, the contents of which are hereby referenced in its entirety.

### TECHNICAL FIELD

This disclosure relates to engines and generators for drones.

### BACKGROUND

A typical conventional multi-rotor unmanned aerial vehicle (UAV) is significantly less complex, easier to operate, less expensive, and easier to maintain than a typical conventional single rotor aerial vehicle, such as a helicopter or similar aerial vehicle. For example, a conventional multi-rotor UAV may include four or more rotor motors, four or more propellers coupled thereto, four or more electronic speed controllers, a flight control system (auto pilot), an RC radio control, a frame, and a rechargeable battery, such as a lithium polymer (LiPo) or similar rechargeable battery. In contrast, a single rotor aerial vehicle, such as a helicopter, may have thousands of parts. Additionally, single rotor aerial vehicles are also notoriously difficult to operate, diagnose problems, and are expensive to maintain.

Multi-rotor UAVs can perform vertical take-off and landing (VTOL) and are capable of aerial performance with similar maneuverability to single rotor aerial vehicles. Multi-rotor UAVs are relatively easy to assemble and may use commercial off the shelf (COTS) hardware including auto pilot flight controllers that are easily adaptable to standard configurations, e.g., a quad-rotor, a hex-rotor, an octo-rotor, and the like.

A typical conventional multi-rotor UAV relies solely on a rechargeable battery or batteries to provide power to drive the rotor motors coupled to the propellers to provide flight. In operation, the battery is used for the entire flight of a conventional multi-rotor UAV. Thus, when the battery is depleted, the UAV will stop operating. If the UAV is in flight, this can result in a catastrophic crashing of the UAV. Additionally, if aggressive maneuvers are needed during flight, such as quickly veering away from an object or moving quickly to avoid a potential threat, such maneuvers require instantaneous peak power which can quickly deplete the battery and reduce flight time significantly. Thus, conventional battery-powered multi-rotor UAVs have limited endurance and payload and provide no backup power in the event the battery supply is depleted.

Conventional portable generators are heavy and may be difficult to transport to desired locations. Micro grid power systems used for electric grid power backup or ultra-micro power systems used in cell towers for power backup rely solely on batteries to provide the needed backup power.

Thus, there is a need for a small, lightweight, portable generator system that can provide power in such applications. Additionally, there is a need for UAVs with improved operational characteristics. For example, there is a need for UAVs capable of operating for longer durations.

### SUMMARY

An integrated micro hybrid generator system can provide a reliable, efficient, lightweight, portable generator system that can be used in both commercial and residential applications to provide power at locations away from a power grid.

The integrated micro hybrid generator system is a self-contained power unit including an engine integrated with a generator assembly that includes a generator fan to cool the generator assembly. The engine and generator assembly are directly coupled, allowing for a compact design and eliminating the need for extraneous coupling parts. Advantages include reducing complexity of the on-board generator and increasing reliability for a UAV that uses the integrated micro hybrid generator system.

In one aspect, an integrated micro hybrid generator system is featured. The integrated micro hybrid generator system is configured to provide power to at least one rotor motor of an unmanned aerial vehicle, including an engine configured to generate mechanical energy, and a generator motor directly coupled to the engine and configured to generate AC power using the mechanical energy generated by the engine.

Implementations can include one or more of the following features. In some implementations, the engine can be directly coupled to the generator motor by a single shared shaft. In some implementations, the mechanical energy generated by the engine is transferred to the generator motor via the shared shaft. In some implementations, the engine can be coupled to the generator motor such that the engine and generator motor share a bearing. In some implementations, the generator can act as a flywheel to store the mechanical energy from the engine as rotational energy. In some implementations, the integrated micro hybrid generator system can include a fan to dissipate heat away from the integrated micro hybrid generator system. In some implementations, the generator motor can include a rotor that is configured to dissipate heat away from the integrated micro hybrid generator system as the rotor rotates. In some implementations, the rotor can include one or more spokes configured to move air over the integrated micro hybrid generator system as the rotor rotates.

In another aspect, an unmanned aerial vehicle is featured. The unmanned aerial vehicle includes a central body, at least one rotor motor configured to drive at least one propeller to rotate, rotation of the at least one propeller generating thrust and causing the unmanned aerial vehicle to fly, and an integrated micro hybrid generator system attached to the central body. The integrated micro hybrid generator system is configured to provide power to the at least one rotor motor and includes an engine configured to generate mechanical energy, and a generator motor directly coupled to the engine. The generator is configured to generate AC power using the mechanical energy generated by the engine.

Implementations can include one or more of the following features. In some implementations, the engine can be directly coupled to the generator motor by a single shared shaft. In some implementations, the mechanical energy generated by the engine can be transferred to the generator motor via the shared shaft. In some implementations, the engine can be coupled to the generator motor such that the engine and generator motor share a bearing. In some implementations, the generator can act as a flywheel to store the mechanical energy from the engine as rotational energy. In some implementations, the unmanned aerial vehicle can include a fan to dissipate heat away from the integrated micro hybrid generator system. In some implementations, the integrated micro hybrid generator system can be coupled to the central body using a dual vibration damping system. In some implementations, the unmanned aerial vehicle can include a rechargeable battery. In some implementations, the generator motor can include a rotor that is configured to dissipate heat away from the integrated micro hybrid generator as the rotor rotates. In some implementations, the rotor can include one or more spokes configured to move air over the integrated micro hybrid generator as the rotor rotates.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 depicts a diagram of an example integrated micro hybrid generator system.

FIG. 2 depicts an exploded perspective view of an integrated micro hybrid generator system.

FIG. 3 depicts a perspective view of a partially assembled integrated micro hybrid generator.

FIG. 4 depicts an exploded side view of an integrated micro hybrid generator.

FIG. 5 is a perspective view of a UAV that includes an integrated micro hybrid generator system.

Like reference symbols in the various drawings indicate like elements.

### DETAILED DESCRIPTION

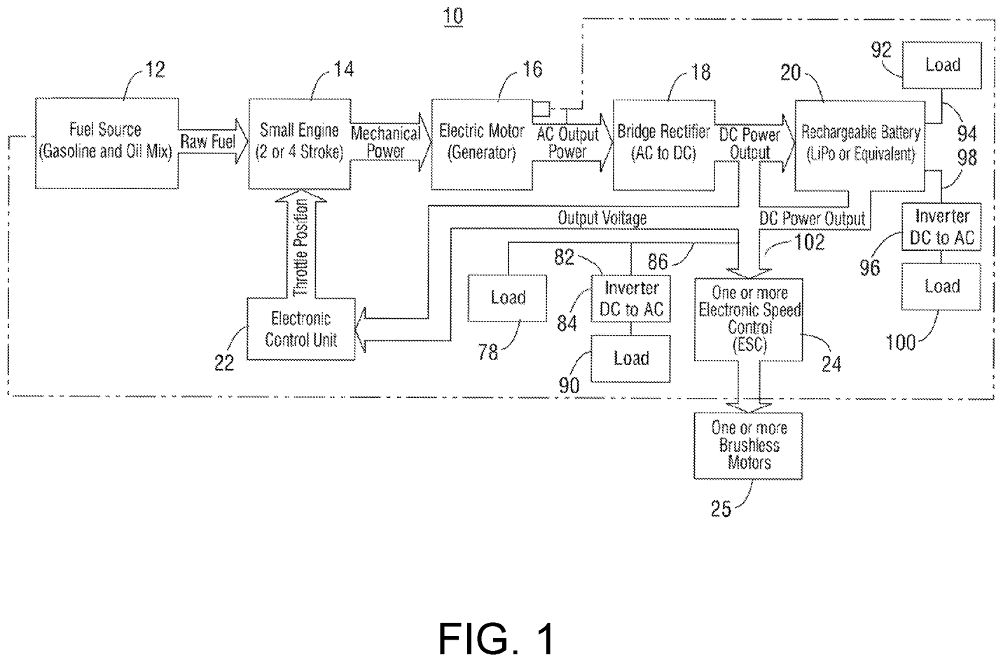

FIG. 1 depicts a diagram of an example integrated micro hybrid generator system 10. The integrated micro hybrid generator system 10 includes a fuel source 12, e.g., a vessel for storing gasoline, a mixture of gasoline and oil mixture, or similar fuel or mixture. The fuel source 12 provides fuel to an engine 14. The engine 14 uses the fuel provided by the fuel source 12 to generate mechanical energy. In one example, the engine 14 is small and has dimensions of about 12″ by 11″ by 6″ and a weight of about 3.5 lbs. to allow for integration into a UAV.

The integrated micro hybrid generator system 10 includes a generator assembly 16 directly coupled to the engine 14. The generator assembly 16 functions to generate AC output power using mechanical power generated by the engine 14. In various embodiments, the integrated micro hybrid generator system 10 includes a fan that dissipates heat away from the engine 14 and/or from the generator assembly 16. The engine 14 that provides approximately between 15-16.5 horsepower, e.g., a modified Desert Aircraft® DA-150.

The integrated micro hybrid generator system 10 includes a bridge rectifier 18 and a rechargeable battery 20. The bridge rectifier 18 is coupled between the generator assembly 16 and the rechargeable battery 20 and converts the AC output of the generator assembly 16 to DC power. The DC power can charge the rechargeable battery 20, provide DC power to a load 78 via line 82, or power to a DC-to-AC inverter 84 via line 86 that then provides AC power to a load 90. The rechargeable battery 20 can provide DC power to a load 92 via a line 94 or to a DC-to-AC inverter 96 via a line 98 that then provides AC power to a load 100.

An output of the bridge rectifier 18 and/or the rechargeable battery 20 of the integrated micro hybrid generator system 10 is provided via line 102 to one or more electronic speed control devices (ESC) 24 integrated in one or more brushless motors 25 (e.g., one or more rotor motors) as part of an UAV. The ESC 24 can control the DC power provided by the bridge rectifier 18 and/or rechargeable battery 20 to one or more rotor motors. In one example, the ESC 24 can be a T-Motor® ESC 45A (2-6S) (available from T-Motor, Jiangxi, China) with SimonK. In one example, the bridge rectifier 18 can be a model #MSD I00-08, diode bridge 800V IOOA SM3, available from Microsemi® Power Products Group (Aliso Viejo, California).

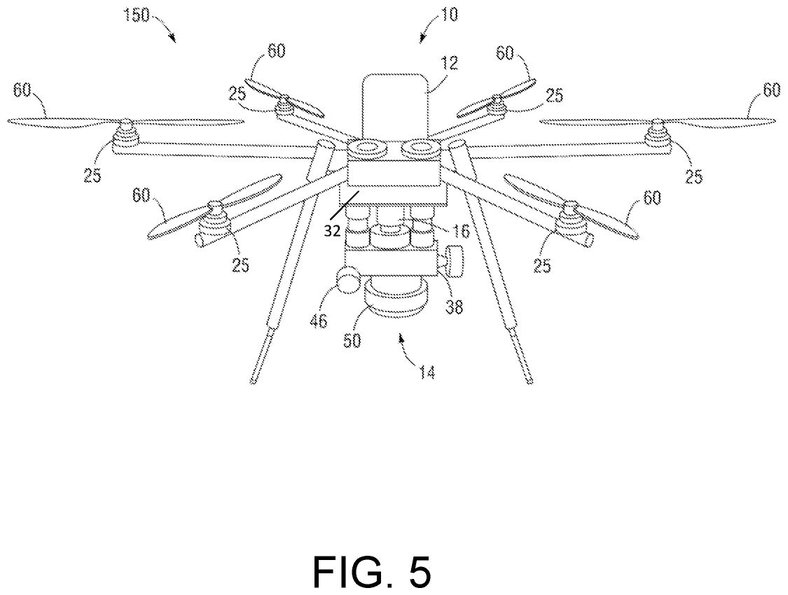

The ESC 24 can control an amount of power provided to one or more rotor motors 25 (FIG. 5) in response to input received from an operator. For example, if an operator provides input to move a UAV to the right, then the ESC 24 can provide less power to rotor motors 25 on the right of the UAV to cause the rotor motors to spin propellers on the right side of the UAV slower than propellers on the left side of the UAV. As power is provided at varying levels to one or more rotor motors 25, a load, e.g., an amount of power provided to the one or more rotor motors 25, can change in response to input received from an operator.

The integrated micro hybrid generator system 10 includes an electronic control unit (ECU) 22. The ECU 22 is coupled to the bridge rectifier 18 and the rechargeable battery 20. The ECU 22 can be configured to measure the AC voltage of the output of the generator assembly 16, which is directly proportional to the revolutions per minute (RPM) of the engine 14, and compares it to the DC power output of the bridge rectifier 18. The ECU 22 can control the throttle of the engine 14 to cause the DC power output of the bridge rectifier 18 to increase or decrease as the load changes, e.g., a load of one or more electric motors 25 or one or more of loads 78, 90, 92, and 100. In one example, the ECU 22 can be an Arduino® MEGA 2560 Board R3.

In one example, the integrated micro hybrid generator system 10 has dimensions of about 12″ by 12″ by 12″ and a weight of about 8 lbs. While the integrated micro hybrid generator system 10 is described as an example, in some implementations, integrated micro hybrid generator systems may have additional elements and/or only a portion of the elements shown in the integrated micro hybrid generator system 10. For example, in some implementations, components such as the fuel source 12, the ESC 24, the one or more brushless motors 25, the electronic control unit 22, the inverters 84, 96 and/or the loads 78, 90, 92, 100 can be separate components not included in the integrated micro hybrid generator system.

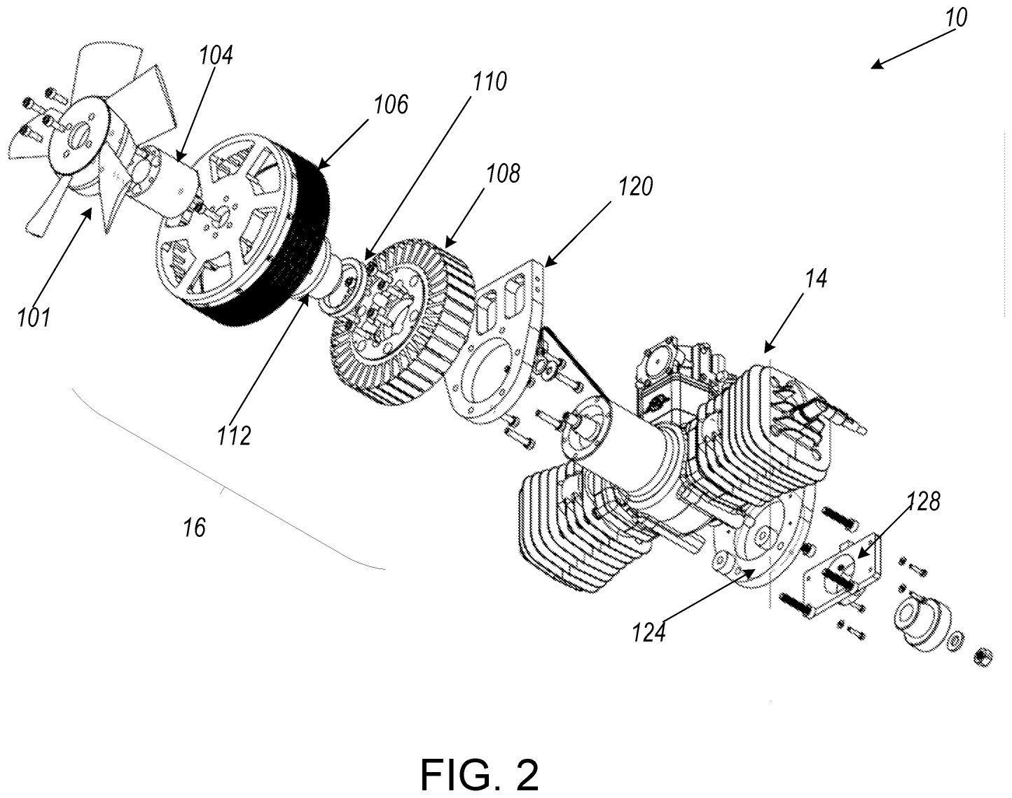

FIG. 2 depicts a perspective exploded view of an integrated micro hybrid generator system 10. The integrated micro hybrid generator system 10 includes an engine 14 coupled to generator assembly 16. The generator assembly 16 includes a rotor 106 that is coupled to a stator 108 by a bearing 110. The generator assembly 16 is coupled to a generator fan 101 by a fan mount 104 that cools the generator assembly 16. The engine 14 can be started using an electric starter. A fuel source 12, as shown in FIG. 1 delivers fuel to the engine 14 to spin the rotor 106 that is part of the generator assembly 16. The spinning of the rotor 106 relative to the stator 108 of the generator assembly 16 generates electricity. The generator assembly 16 can be an out-runner generator, a design that allows for greater reliability of the generator unit, and also acts as a flywheel for the engine by storing rotational energy generated by the engine (kinetic energy), improving engine efficiency. In some implementations, the rotor 106 can include spokes that are shaped like fan vanes such that rotation of the rotor 106 moves air over the generator assembly 16 to cool the generator assembly 16. In such implementations, the fan 101 and the rotor 106 can be integrated into a single component rather than requiring separate components for the fan 101, fan mount 104, and/or the rotor 106. This can have the advantage reducing the weight and increasing the efficiency of the generator assembly 16.

The engine 14 is modified from a typical off-the-shelf engine, e.g., a DA-150 engine. These modifications allow for mounting of the generator assembly 16 directly onto the engine 14 via an engine hub 112. In the integrated micro hybrid generator system 10, the engine 14 and generator assembly 16 share the same shaft (e.g., engine hub 112 and the generator assembly 16 do not have separate shafts). The bearing 110 is shared between the engine 14 and the generator assembly 16, rather than the multiple bearings typically found in such a system. This arrangement simplifies the number of parts required. Additional custom coupling pieces attach the engine 14 and generator assembly 16.

Power output from generator assembly 16 can be in the form of alternating current (AC) that needs to be rectified by bridge rectifier 18 (shown in FIG. 1). Bridge rectifier 18 can convert the AC power into direct current (DC) power, as discussed above. In various embodiments, the output power of the integrated micro hybrid generator system 10 can be placed in a “serial hybrid” configuration, where the generator power output by generator assembly 16 can be available to charge the rechargeable battery 20 or provide power to another external load.

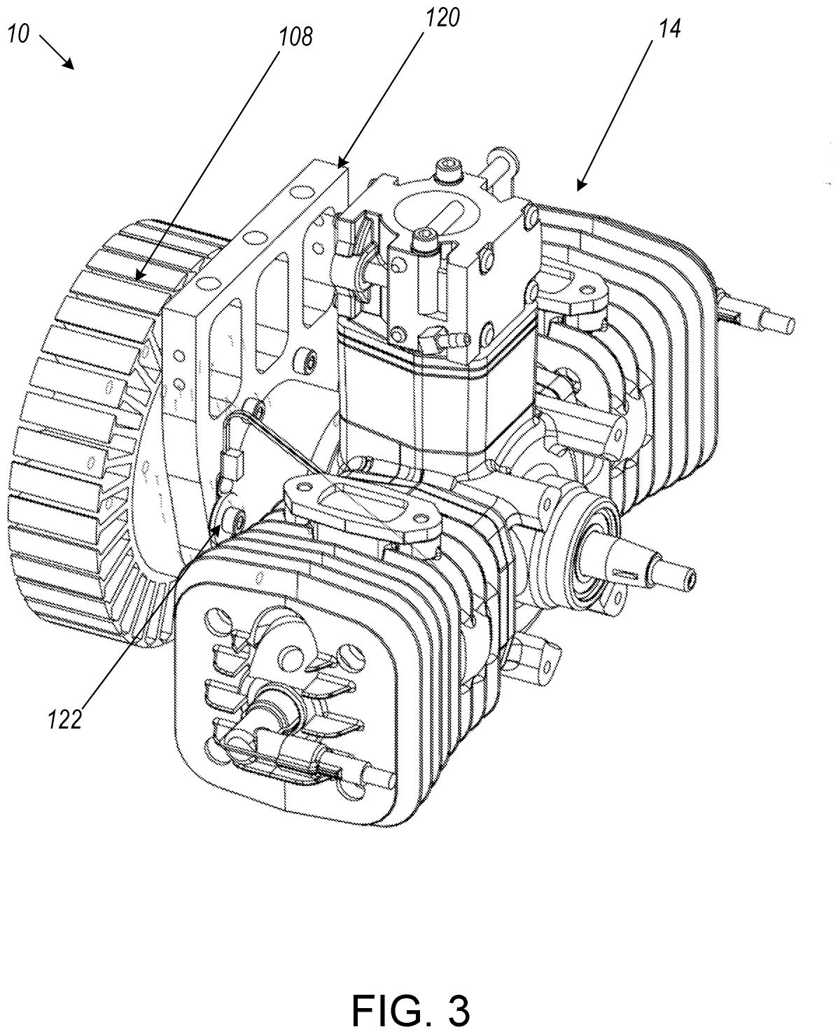

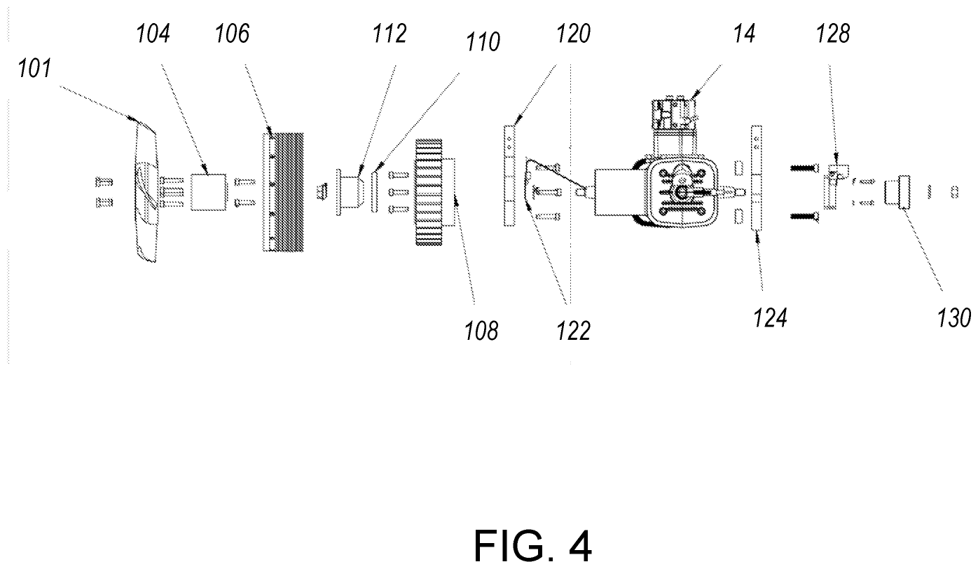

Referring as well to FIGS. 3 and 4, assembling the integrated micro hybrid generator system 10 can include the following steps. First, the rear engine mount plate frame 120 is mounted to the stator 108. A thermal sensor 122 can be placed on the side of the generator assembly 16, for example on the rear engine mount plate 120 as best shown in FIG. 3. The stator 108 is attached to the engine 14 via the rear engine mount plate frame 120, using adhesive, screws, bolts, and/or lubricant as appropriate.

Next, the front engine mount frame 124 is attached to the engine 14, on the opposite side of the engine 14 as is the rear engine mount plate frame 120. Adhesive, screws, bolts, and/or lubricant as appropriate can be used.

Next, a crankshaft position sensor assembly 128 is fixed to the opposite side of the front engine mount frame 124 from the engine 14. A servo rod assembly can also be mounted to pass through the front engine mount frame 124. The engine hub 112 is then affixed to the stator 108, with the bearing 110 located within the stator 108.

Referring as well to FIG. 4, a magnet holder 130 is installed. The front of the magnet holder 130 is etched to mark the leading edge of a magnet. When viewed from the larger diameter of the magnet holder 130, the magnet will rotate clockwise. The magnet holder 130 is placed so that a marked line on the crankshaft position sensor assembly 128 lines up with the leading edge of the magnet. Appropriate adhesives, nuts, and/or washers are used to assemble this component. The rotor 106 is then installed, as is the generator fan 101.

FIG. 5 is a perspective view of a UAV 150 that has a central body 32 and includes an integrated micro hybrid generator system 10. The UAV 150 pictured includes six rotor motors 25 each coupled to propellers 60; however a UAV with an integrated micro hybrid generator system 10 can include more or fewer rotor motors and propellers. The UAV 150 can include a Px4 flight controller® implemented as part of a 3 DR Pixhawk®.

In various embodiments, the integrated micro hybrid generator system 10 includes components to facilitate transfer of heat away from the integrated micro hybrid generator system 10 and/or is integrated within a UAV to increase airflow over components that produce heat. For example, the hybrid generator system 10 can include cooling fins on specific components, e.g., the rectifier, to transfer heat away from the integrated micro hybrid generator system. In various implementations, the integrated micro hybrid generator system 10 includes components and is integrated within a UAV to cause heat to be transferred towards the exterior of the UAV

In various embodiments, the integrated micro hybrid generator system 10 is integrated as part of a UAV using a dual vibration damping system. An engine 14 of the integrated micro hybrid generator system can utilize couplings to accommodate for misalignment between the engine and generator. A dual vibration damping system using both compression and torsional dampers can provide damping between the integrated micro hybrid generator system 10 and a structure to which it is mounted, e.g. a drone.

The ECU 22, and other applicable systems described in this paper, can be implemented as a computer system, a plurality of computer systems, or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, Ethernet interface, satellite transmission interface (e.g., “direct PC”), or other interfaces for coupling a computer system to other computer systems. Interfaces enable computer systems and other devices to be coupled together in a network.

A computer system can be implemented as a module, as part of a module, or through multiple modules. As used in this paper, a module includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the module's functionality, or the like. As such, a first module and a second module can have one or more dedicated processors, or a first module and a second module can share one or more processors with one another or other modules. Depending upon implementation-specific or other considerations, a module can be centralized or its functionality distributed. A module can include hardware, firmware, or software embodied in a computer-readable medium for execution by the processor. The processor transforms data into new data using implemented data structures and methods, such as is described with reference to the FIGS. in this paper.

Further relevant details are described in U.S. Pat. No. 9,751,625 issued Sep. 5, 2017, U.S. Pat. No. 9,902,495 issued Feb. 27, 2018, and U.S. Pat. No. 10,017,266 issued Jul. 10, 2018, the contents of which patents are incorporated by reference herein in their entireties.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art.

A number of embodiments of the invention have been described. Nevertheless, it will be understood that various modifications may be made without departing from the spirit and scope of the invention. Accordingly, other embodiments are within the scope of the following claims.

What is claimed is:

1. An integrated micro hybrid generator system configured to provide power to at least one rotor motor of an unmanned aerial vehicle, comprising:
an engine configured to generate mechanical energy, and
a generator motor directly coupled to the engine and configured to generate AC power using the mechanical energy generated by the engine.

2. The system of claim 1, wherein the engine is directly coupled to the generator motor by a single shared shaft.

3. The system of claim 2, wherein the mechanical energy generated by the engine is transferred to the generator motor via the shared shaft.

4. The system of claim 2, wherein the engine is coupled to the generator motor such that the engine and generator motor share a bearing.

5. The system of claim 1, wherein the generator motor acts as a flywheel to store the mechanical energy from the engine as rotational energy.

6. The system of claim 1, further comprising a fan to dissipate heat away from the integrated micro hybrid generator system.

7. The system of claim 1, wherein the generator motor comprises a rotor that is configured to dissipate heat away from the integrated micro hybrid generator system as the rotor rotates.

8. The system of claim 7, wherein the rotor comprises one or more spokes configured to move air over the integrated micro hybrid generator system as the rotor rotates.

9. An unmanned aerial vehicle comprising:
a central body;
at least one rotor motor configured to drive at least one propeller to rotate, rotation of the at least one propeller generating thrust and causing the unmanned aerial vehicle to fly; and
an integrated micro hybrid generator system attached to the central body and configured to provide power to the at least one rotor motor, comprising:
an engine configured to generate mechanical energy, and
a generator motor directly coupled to the engine and configured to generate AC power using the mechanical energy generated by the engine.

10. The unmanned aerial vehicle of claim 7, wherein the engine is directly coupled to the generator motor by a single shared shaft.

11. The unmanned aerial vehicle of claim 8, wherein the mechanical energy generated by the engine is transferred to the generator motor via the shared shaft.

12. The unmanned aerial vehicle of claim 8, wherein the engine is coupled to the generator motor such that the engine and generator motor share a bearing.

13. The unmanned aerial vehicle of claim 7, wherein the generator motor acts as a flywheel to store the mechanical energy from the engine as rotational energy.

14. The unmanned aerial vehicle of claim 7, further comprising a fan to dissipate heat away from the integrated micro hybrid generator system.

15. The unmanned aerial vehicle of claim 7, wherein the integrated micro hybrid generator system is coupled to the central body using a dual vibration damping system.

16. The unmanned aerial vehicle of claim 7, further comprising a rechargeable battery.

17. The unmanned aerial vehicle of claim 7, wherein the generator motor comprises a rotor that is configured to dissipate heat away from the integrated micro hybrid generator as the rotor rotates.

18. The unmanned aerial vehicle of claim 17, wherein the rotor comprises one or more spokes configured to move air over the integrated micro hybrid generator as the rotor rotates.
